(19) United States
(12) Patent Application Publication
(10) Pub. No.: US 2005/0232086 A1
(43) Pub. Date: Oct. 20, 2005

(54) Time zone based GPS date and time

(75) Inventors: Nada S. Jiddou, West Bloomfield, MI (US); William E. Mazzara JR., Drayton Plains, MI (US)

Correspondence Address: ANTHONY LUKE SIMON;General Motors Corporation, 300 Renaissance Center, Mail Code 482-C23-B21, P.O. Box 300, Detroit, MI, 48265-3000, US

(73) Assignee: General Motors Corporation

(21) Appl. No.: 10/823,830

(22) Filed: Apr. 14, 2004

(51) Int. Cl. H04B 7/185; G01S 1/00

(52) U.S. Cl. 368/47

(57) ABSTRACT

A system and method for determining a time zone based date and time from a Global Positioning System (GPS) signal, the method including receiving a time zone reference signal at a telematics device, determining a local Coordinated Universal Time (UTC) correction from the time zone reference signal, storing the local UTC correction, and calculating local time from the local UTC correction and the GPS signal. In one embodiment, the time zone reference signal is the GPS signal. In an alternative embodiment, the time zone reference signal is a Code Division Multiple Access (CDMA) signal. In yet another alternative embodiment, the method includes scheduling mobile vehicle communication system activities based on the local time.

### FIELD OF THE INVENTION

The invention relates to vehicles, and more particularly to methods and systems for obtaining local time and date information for a vehicle.

### BACKGROUND OF THE INVENTION

A growing number of vehicles are equipped with telematic devices as part of a mobile vehicle communication system, which provides voice and data communication with the vehicle. Such telematic devices are typically equipped with Global Positioning Systems (GPSs) using satellite technology to allow determination of the vehicle's location. The GPS signal also provides a time and date under the Coordinated Universal Time (UTC) standard, which provides a single time regardless of the geographical location in the world.

All activity involving the telematic devices is presently based on the UTC time without regard for the local time at the vehicle location. This presents problems because some tasks are better performed in off hours when the vehicle is not likely to be in use, while other tasks are better performed when the vehicle is likely to be in use. For example, Vehicle Data Uploads (VDUs) transfer stored mobile vehicle data from the telematic devices to a centralized data storage location. VDUs are performed simultaneously at a single UTC time for all the telematic devices in a large geographic region. The mobile vehicle communication system must be sized to carry this peak traffic, although the system capacity is unused most of the time. Meeting the peak traffic increases costs and design complexity.

It would be desirable to have a method and system for obtaining local time and date information for a vehicle that overcomes the above disadvantages.

### SUMMARY OF THE INVENTION

The present invention provides a method for determining a time zone based date and time from a Global Positioning System (GPS) signal, the method including receiving a time zone reference signal at a telematics device, determining a local Coordinated Universal Time (UTC) correction from the time zone reference signal, storing the local UTC correction, and calculating local time from the local UTC correction and the GPS signal.

Another aspect of the present invention provides a system for determining a time zone based date and time from a Global Positioning System (GPS) signal, the system including means for receiving a time zone reference signal at a telematics device, means for determining a local Coordinated Universal Time (UTC) correction from the time zone reference signal, means for storing the local UTC correction, and means for calculating local time from the local UTC correction and the GPS signal.

Yet another aspect of the present invention provides a computer readable medium storing a computer program for determining a time zone based date and time from a Global Positioning System (GPS) signal, the computer program including computer readable code for receiving a time zone reference signal at a telematics device, computer readable code for determining a local Coordinated Universal Time (UTC) correction from the time zone reference signal, computer readable code for storing the local UTC correction, and computer readable code for calculating local time from the local UTC correction and the GPS signal.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustrative operating environment for determining a time zone based date and time from a Global Positioning System (GPS) signal in accordance with the present invention.

FIG. 2 is a process flow diagram for determining a time zone based date and time from a Global Positioning System (GPS) signal in accordance with the present invention.

### DETAILED DESCRIPTION OF THE PRESENTLY PREFERRED EMBODIMENT

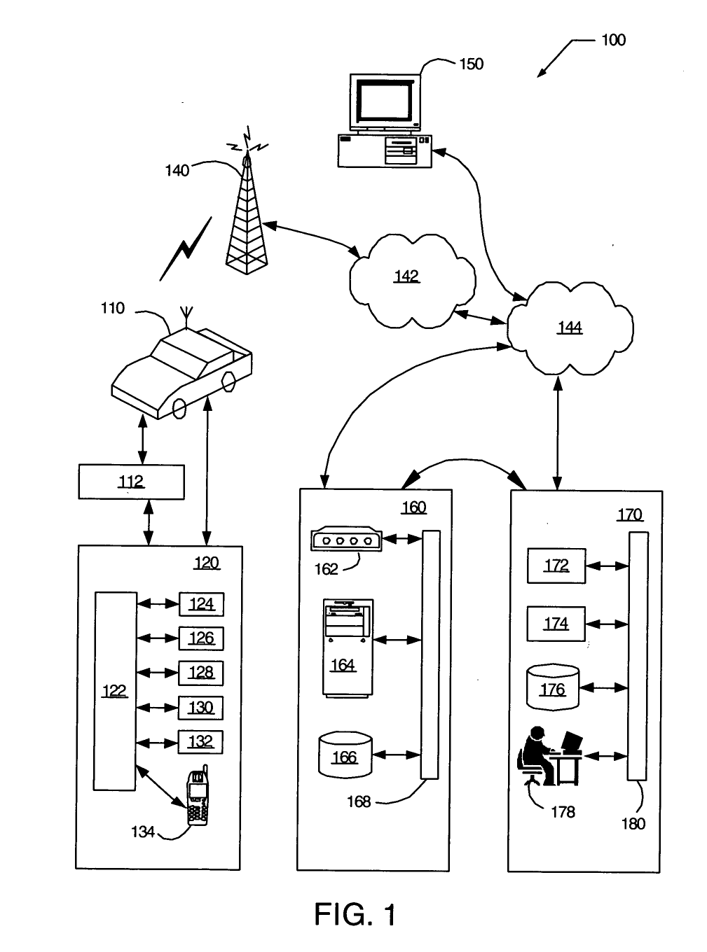

FIG. 1 is an illustrative operating environment for determining a time zone based date and time from a Global Positioning System (GPS) signal in accordance with the present invention. FIG. 1 shows a mobile vehicle communication system 100. Mobile communication system 100 includes at least one mobile vehicle 110 (vehicle) including vehicle communication bus 112 and telematics device 120, one or more wireless carrier systems 140, one or more communication networks 142, one or more land networks 144, one or more client, personal or user computers 150, one or more web-hosting portals 160, and one or more call centers 170. In one embodiment, mobile vehicle 110 is implemented as a vehicle equipped with suitable hardware and software for transmitting and receiving voice and data communications. The telematics device 120 is also called a vehicle communications unit (VCU) or a telematics unit.

In one embodiment, the telematics device 120 includes a processor 122 connected to a wireless modem 124, a global positioning system (GPS) unit 126, an in-vehicle memory 128, such as, for example, a non-volatile flash memory, a microphone 130, one or more speakers 132, and an embedded or in-vehicle mobile phone 134. In one embodiment, processor 122 is a microcontroller, controller, host processor, or vehicle communications processor. In an example, processor 122 is implemented as an application specific integrated circuit (ASIC). In another example, processor 122 is a digital signal processor (DSP). GPS unit 126 provides longitude and latitude coordinates of the vehicle, as well as a time and date stamp. In-vehicle mobile telephone system 134 is a cellular-type phone, such as, for example an analog, digital, dual-mode, dual-band, multi-mode or multi-band cellular phone. In another example, the mobile telephone system is an analog mobile telephone system operating over a prescribed band nominally at 800 MHz. In another example, the mobile telephone system is a digital mobile telephone system operating over a prescribed band nominally at 800 MHz, 900 MHz, 1900 MHz, or any suitable band capable of carrying digital cellular communications.

Processor 122 executes various computer programs and communication control and protocol algorithms that affect communication, programming and operational modes of electronic and mechanical systems within vehicle 110. In one embodiment, processor 122 is an embedded system controller. In another embodiment, processor 122 controls communications between telematics device 120, wireless carrier system 140, and call center 170. In yet another embodiment, processor 122 controls communications between the wireless modem 124 and nodes of a mobile ad hoc network. In still another embodiment, processor 122 provides processing, analysis and control functions for determining engine emission performance for vehicle 110. Processor 122 is configured to generate and receive digital signals transmitted between telematics device 120 and a vehicle communication bus 112 that is connected to various electronic modules in the vehicle 110. In one embodiment, the digital signals activate a programming mode and operation modes, as well as provide for data transfers. In another embodiment, a utility program facilitates the transfer of emission data, emission analysis data, instructions, triggers and data requests between vehicle 110 and a call center 170.

Mobile vehicle 110, via a vehicle communication bus 112, sends signals to various units of equipment and systems within vehicle 110 to perform various functions such as monitoring the operational state of vehicle systems, collecting and storing data from the vehicle systems, providing instructions, data and programs to various vehicle systems and calling from telematics device 120. In facilitating interactions among the various communication and electronic modules, vehicle communication bus 112 utilizes bus interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication bus 112 is a direct connection between connected devices.

Vehicle 110, via telematics device 120, sends and receives radio transmissions from wireless carrier system 140. Wireless carrier system 140 is implemented as any suitable system for transmitting a signal from mobile vehicle 110 to communication network 142. Wireless carrier system 140 incorporates any type of telecommunications in which electromagnetic waves carry signal over part of or the entire communication path. In one embodiment, wireless carrier system 140 transmits analog audio and/or video signals. In an example, wireless carrier system 140 transmits analog audio and/or video signals such as those sent from AM and FM radio stations and transmitters, or digital audio signals in the S band (approved for use in the U.S.) and L band (used in Europe and Canada). In one embodiment, wireless carrier system 140 is a satellite broadcast system broadcasting over a spectrum in the “S” band (2.3 GHz) that has been allocated by the U.S. Federal Communications Commission (FCC) for nationwide broadcasting of satellite-based Digital Audio Radio Service (DARS).

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to mobile vehicle 110 and land network 144. In one example, wireless carrier system 140 includes a short message service, modeled after established protocols such as IS-637 SMS standards, IS-136 air interface standards for SMS, and GSM 03.40 and 09.02 standards. Similar to paging, an SMS communication could be broadcast to a number of regional recipients. In another example, the carrier system 140 uses services in accordance with other standards, such as, for example, IEEE 802.11 compliant wireless systems and Bluetooth compliant wireless systems.

Land network 144 is a public-switched telephone network (PSTN). In one embodiment, land network 144 is implemented as an Internet protocol (IP) network. In other embodiments, land network 144 is implemented as a wired network, an optical network, a fiber network, another wireless network, a virtual private network (VPN) or any combination thereof. Land network 144 is connected to one or more landline telephones. Land network 144 connects communication network 142 to user computer 150, web-hosting portal 160, and call center 170. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160 and vehicle 110. Personal or user computer 150 sends data to web-hosting portal through a web-page interface using communication standards such as hypertext transport protocol (HTTP), and transport-control protocol Internet protocol (TCP/IP). In one embodiment, the data includes directives to change certain programming and operational modes of electronic and mechanical systems within vehicle 110. In another embodiment, the data includes requests for certain data such as vehicle system performance information. In operation, a user, such as, for example, a vehicle designer or manufacturing engineer, utilizes user computer 150 to exchange information with mobile vehicle 110 that is cached or stored in web-hosting portal 160. In an embodiment, vehicle system performance information from client-side software is transmitted to server-side software of web-hosting portal 160. In one embodiment, vehicle system performance information is stored at web-hosting portal 160. In another embodiment, client computer 150 includes a database (not shown) for storing received vehicle system performance data. In yet another embodiment, a private Local Area Network (LAN) is implemented for client computer 150 and web-hosting portal 160, such that web-hosting portal is operated as a Virtual Private Network (VPN).

Web-hosting portal 160 includes one or more data modems 162, one or more web servers 164, one or more databases 166, and a network 168. Web-hosting portal 160 is connected directly by wire to call center 170, or connected by phone lines to land network 144, which is connected to call center 170. Web-hosting portal 160 is connected to land network 144 by one or more data modems 162. Land network 144 sends digital data to and from modem 162; data that is subsequently transferred to web server 164. In one implementation, modem 162 resides inside web server 164. Land network 144 transmits data communications between web-hosting portal 160 and call center 170.

Web server 164 receives various data, requests or instructions from user computer 150 via land network 144. In alternative embodiments, user computer 150 includes a wireless modem to send data to web-hosting portal 160 through a wireless communication network 142 and a land network 144. Data is received by modem 162 and sent to one or more web servers 164. In one embodiment, web server 164 is implemented as any suitable hardware and software capable of providing web services to transmit and receive data from user computer 150 to telematics device 120 in vehicle 110. Web server 164 sends to or receives data transmissions from one or more databases 166 via network 168. In an embodiment, web server 164 includes computer applications and files for managing emission performance data.

In one embodiment, one or more web servers 164 are networked via network 168 to distribute vehicle engine emission performance data among its network components such as database 166. In an example, database 166 is a part of or a separate computer from web server 164. In one embodiment, web-server 164 sends data transmissions including vehicle system performance information to call center 170 via modem 162, and through land network 144.

Call center 170 is a location where many calls are received and serviced at the same time, or where many calls are sent at the same time. In one embodiment, the call center is a telematics call center, facilitating communications to and from telematics device 120 in vehicle 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more networks 180.

Switch 172 of call center 170 connects to land network 144. Switch 172 transmits voice or data transmissions from call center 170, and receives voice or data transmissions from telematics device 120 in mobile vehicle 110 through wireless carrier system 140 and/or wireless modem 124, communication network 142, and land network 144. Switch 172 receives data transmissions from, and sends data transmissions to, one or more web-hosting portals 160. Switch 172 receives data transmissions from, or sends data transmissions to, one or more communication services managers 174 via one or more networks 180.

Communication services manager 174 is any suitable hardware and software capable of providing communication services to telematics device 120 in mobile vehicle 110. Communication services manager 174 sends to or receives data transmissions from one or more communication services databases 176 via network 180. Communication services manager 174 sends to or receives data transmissions from one or more communication services advisors 178 via network 180. Communication services database 176 sends to or receives data transmissions from communication services advisor 178 via network 180. Communication services advisor 178 receives from or sends to switch 172 voice or data transmissions.

Communication services manager 174 facilitates one or more services, such as, but not limited to, enrollment services, navigation assistance, directory assistance, roadside assistance, business or residential assistance, information services assistance, emergency assistance, and communications assistance and telematics retrieval of vehicle system performance information. In an embodiment, communication services manager 174 receives service requests for a vehicle emission performance data update from a user via user computer 150, web-hosting portal 160, and land network 144. Communication services manager 174 transmits and receives operational status, instructions and other types of vehicle data to telematics device 120 in mobile vehicle 110 through wireless carrier system 140, communication network 142, land network 144, wireless modem 124, voice and data switch 172, and network 180. Communication services manager 174 stores or retrieves vehicle system performance information from communication services database 176. Communication services manager 174 provides requested information to communication services advisor 178.

In one embodiment, communication services advisor 178 is a real advisor. In another embodiment, communication services advisor 178 is implemented as a virtual advisor. In an example, a real advisor is a human being at service provider service center in verbal communication with service subscriber in mobile vehicle 110 via telematics device 120. In another example, a virtual advisor is implemented as a synthesized voice interface responding to requests from telematics device 120 in mobile vehicle 110. In another embodiment, communication services advisor 178 is embodied in software executing on a computing system that provides automated configurable dynamic telematic retrieval of vehicle system performance information.

Communication services advisor 178 provides services to telematics device 120 in mobile vehicle 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics device 120 in mobile vehicle 110 through wireless carrier system 140, communication network 142, and land network 144 using voice transmissions, or through communication services manager 174 and switch 172 using data transmissions. Switch 172 selects between voice transmissions and data transmissions.

Mobile vehicle 110 initiates service requests to call center 170 by sending a voice or digital-signal command to telematics device 120 which in turn, sends an instructional signal or a voice call through wireless modem 124, wireless carrier system 140, communication network 142, and land network 144 to call center 170. In another embodiment, the service request is for an vehicle system performance information upload that initiates a vehicle system performance information transfer between vehicle 110 and service center 170 or web-hosting portal 160. In another embodiment, the mobile vehicle 110 receives a request from call center 170 to send various types of vehicle system performance information from mobile vehicle 110 through telematics device 120 through wireless modem 124, wireless modem 124, wireless carrier system 140, communication network 142, and land network 144 to call center 170. In one embodiment, one or more triggers stored in the telematics device 120 cause the vehicle to initiate a service request. The trigger is, for example, a number of ignition cycles, a specific time and date, an expired time, a number of kilometers, an absolute Global Positioning System (GPS) timestamp, a request vehicle emission performance data and the like.

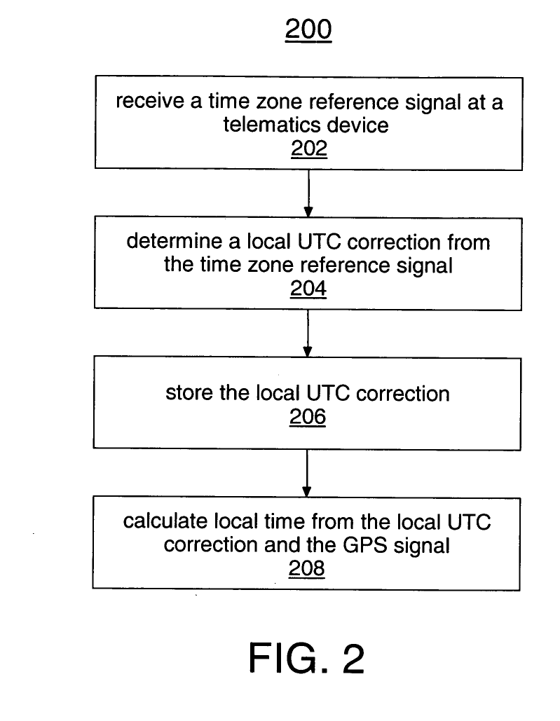

FIG. 2 is a process flow diagram for determining a time zone based date and time from a Global Positioning System (GPS) signal in accordance with an embodiment of the present invention. The method 200 includes receiving a time zone reference signal at a telematics device 202, determining a local Coordinated Universal Time (UTC) correction from the time zone reference signal 204, storing the local UTC correction 206, and calculating local time from the local UTC correction and the GPS signal 208. As used herein, time includes both time-of-day and date information.

Receiving a time zone reference signal at a telematics device 202 is performed once or multiple times depending on the local time calculation that is desired, such as whether the local time is the mobile vehicle's home location time or current location time.

In one embodiment, the local time is the time at the mobile vehicle's home location and does not change with the vehicle's day-to-day location. The reception of a time zone reference signal at a telematics device 202 is performed for the initial telematics device configuration for the first vehicle owner, telematics device reconfigurations for subsequent vehicle owners, or telematics device configurations with changes in the mobile vehicle's home location. In one embodiment, the local time at the mobile vehicle's home location is checked by later reception of the time zone reference signal.

In an alternative embodiment, the local time is the time at the mobile vehicle's current location and changes with the vehicle's current location. The reception of a time zone reference signal at a telematics device 202 is performed intermittently or regularly on a vehicle triggered event or a system triggered event. Vehicle triggered events are triggered by an event at the mobile vehicle, such as starting the vehicle or periodic signals from a vehicle timer. System triggered events are triggered by an event in the rest of the mobile vehicle communication system, such as an event at the computer, web-hosting portal, or the call center. Examples of system triggered events are communication services advisor requests and periodic signals from a system timer. Those skilled in the art will appreciate that the local time as the time at the mobile vehicle's home location is desirable for some functions and local time as the time at the mobile vehicle's current location is desirable for other functions. In one embodiment, both the time at the mobile vehicle's home location and the time at the mobile vehicle's current location are available for different functions in the mobile vehicle communication system.

Determining a local Coordinated Universal Time (UTC) correction from the time zone reference signal 204 depends on the type of time zone reference signal, such as a GPS signal or a Code Division Multiple Access (CDMA) signal.

In one embodiment, the time zone reference signal is a GPS signal, which includes both position information (longitude and latitude) and the current time under the UTC standard. The GPS unit of the telematics device of a mobile vehicle receives the GPS signal from Global Positioning System (GPS) satellites. The vehicle location (longitude and latitude) of the mobile vehicle is determined from the GPS signal and the local time zone determined from the vehicle location. In one embodiment, the local time zone is determined by looking up the local time zone in a table with time zone indexed by longitude and latitude. In an alternative embodiment, the local time zone is determined using an algorithm providing time zone as a function of longitude and latitude.

Once the local time zone has been determined, the local Coordinated Universal Time (UTC) correction for the local time zone is determined. In one embodiment, the local UTC correction is looked up on a table with local UTC correction indexed by local time zone. In one embodiment, the determination of a local Coordinated Universal Time (UTC) correction from the GPS signal is performed at the telematics device. In an alternative embodiment, the determination of a local Coordinated Universal Time (UTC) correction from the GPS signal is performed elsewhere in the mobile vehicle communication system, such as the web-hosting portal or the call center. The GPS signal as received at the mobile vehicle is typically available throughout the mobile vehicle communication system to allow determination of the vehicle location for driver assistance.

In an alternative embodiment, the time zone reference signal is a Code Division Multiple Access (CDMA) signal. The CDMA signal includes CDMA time, UTC time, and CDMA local time correction. The CDMA time is calculated from the UTC time obtained from the GPS satellites and the CDMA local time correction. During configuration of the telematics device for a particular mobile vehicle, the UTC time is determined from the GPS signal received at the GPS unit of the telematics device. The CDMA signal including the CDMA time from the wireless carrier system is also received at the telematics device. The local UTC correction is determined by taking the difference between the UTC time and the CDMA time. In an alternative embodiment, the local UTC correction is determined directly by setting the local UTC correction equal to the CDMA local time correction.

The local UTC correction is stored 206 for use in calculating local time from the local UTC correction and the GPS signal. The local UTC correction is stored in one or more locations depending on where it is most convenient for use, although each portion of the mobile vehicle communication system is able to access the other storage locations. In one embodiment, the local UTC correction is stored in an in-vehicle memory in the mobile vehicle. In an alternative embodiment, the local UTC correction is stored in a web-hosting portal database at the web-hosting portal. In yet another alternative embodiment, the local UTC correction is stored in a communications services database at the call center.

Local time is calculated from the local UTC correction and the GPS signal 208. The GPS signal includes the UTC time, so the calculation of the local time performed by adding (or subtracting, as appropriate) the local UTC correction and the UTC time.

The local time is used to schedule mobile vehicle communication system activities. The communication is from the telematics device to elsewhere in the mobile vehicle communication system or vice versa.

In one embodiment, the local time is used to schedule Vehicle Data Uploads (VDUs), which transfer stored mobile vehicle data from the telematics device to the web-hosting portal and/or the call center. The VDUs for a group of vehicles in a geographic region are assigned various local times to reduce the peak data traffic on the mobile vehicle communication system. Scheduling the VDU at a local time when there is little activity, such as in the middle of the night, allows efficient use of available bandwidth in the mobile vehicle communication system.

In an alternative embodiment, the local time is used to schedule communication from the web-hosting portal and/or the call center to the telematics device in the mobile vehicle. In one example, the user of the vehicle schedules a user requested notice, such as an alarm or reminder, to be delivered to the mobile vehicle from the web-hosting portal or the call center at a user desired local time. The telematics device announces or displays the user requested notice at the desired local time. In another example, the web-hosting portal or the call center schedules a system scheduled notice, such as an announcement or event notice, to be delivered to the telematics device of the mobile vehicle at or before the local time the user of the vehicle is likely to use the vehicle and receive the system scheduled notice. Such system scheduled notices include, but are not limited to vehicle service notifications, advertisements, weather reports and bulletins, traffic conditions, stock reports, and the like. Those skilled in the art will appreciate that the local time is used to schedule any transmission to or from the telematics device for which a specific local time is desired.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A method for determining a time zone based date and time from a Global Positioning System (GPS) signal comprising:
receiving a time zone reference signal at a telematics device;
determining a local Coordinated Universal Time (UTC) correction from the time zone reference signal;
storing the local UTC correction; and
calculating local time from the local UTC correction and the GPS signal.

2. The method of claim 1 wherein the receiving a time zone reference signal at a telematics device comprises receiving a time zone reference signal on occurrence of an event selected from the group consisting of initial telematics device configuration, telematics device reconfiguration, a vehicle triggered event, and a system triggered event.

3. The method of claim 1 wherein the time zone reference signal is a GPS signal and the determining a local Coordinated Universal Time (UTC) correction from the time zone reference signal comprises:
determining a vehicle location from the GPS signal;
determining a local time zone from the vehicle location; and
determining a local UTC correction for the local time zone.

4. The method of claim 1 wherein the time zone reference signal is a Code Division Multiple Access (CDMA) signal including CDMA time and the determining a local Coordinated Universal Time (UTC) correction from the time zone reference signal comprises:
determining UTC time from the GPS signal; and
calculating a local UTC correction from the UTC time and the CDMA time.

5. The method of claim 1 wherein the time zone reference signal is a Code Division Multiple Access (CDMA) signal including a CDMA local time correction and the determining a local Coordinated Universal Time (UTC) correction from the time zone reference signal comprises setting the UTC correction equal to the CDMA local time correction.

6. The method of claim 1 wherein the storing the local UTC correction comprises storing the local UTC correction in a location selected from the group consisting of an in-vehicle memory, a web-hosting portal database, and a communications services database.

7. The method of claim 1 further comprising scheduling mobile vehicle communication system activities based on the local time.

8. The method of claim 7 wherein the scheduling mobile vehicle communication system activities based on the local time comprises scheduling mobile vehicle communication system activities selected from the group consisting of Vehicle Data Uploads (VDUs), user requested notices, and system scheduled notices.

9. A system for determining a time zone based date and time from a Global Positioning System (GPS) signal comprising:
means for receiving a time zone reference signal at a telematics device;
means for determining a local Coordinated Universal Time (UTC) correction from the time zone reference signal;
means for storing the local UTC correction; and
means for calculating local time from the local UTC correction and the GPS signal.

10. The system of claim 9 wherein the means for receiving a time zone reference signal at a telematics device comprises means for receiving a time zone reference signal on occurrence of an event selected from the group consisting of initial telematics device configuration, telematics device reconfiguration, a vehicle triggered event, and a system triggered event.

11. The system of claim 9 wherein the time zone reference signal is a GPS signal and the means for determining a local Coordinated Universal Time (UTC) correction from the time zone reference signal comprises:
means for determining a vehicle location from the GPS signal;
means for determining a local time zone from the vehicle location; and
means for determining a local UTC correction for the local time zone.

12. The system of claim 9 wherein the time zone reference signal is a Code Division Multiple Access (CDMA) signal including CDMA time and the means for determining a local Coordinated Universal Time (UTC) correction from the time zone reference signal comprises:
means for determining UTC time from the GPS signal; and
means for calculating a local UTC correction from the UTC time and the CDMA time.

13. The system of claim 9 wherein the time zone reference signal is a Code Division Multiple Access (CDMA) signal including a CDMA local time correction and the means for determining a local Coordinated Universal Time (UTC) correction from the time zone reference signal comprises means for setting the UTC correction equal to the CDMA local time correction.

14. The system of claim 9 further comprising means for scheduling mobile vehicle communication system activities based on the local time.

15. A computer readable medium storing a computer program for determining a time zone based date and time from a Global Positioning System (GPS) signal, the computer program comprising:
computer readable code for receiving a time zone reference signal at a telematics device;
computer readable code for determining a local Coordinated Universal Time (UTC) correction from the time zone reference signal;
computer readable code for storing the local UTC correction; and
computer readable code for calculating local time from the local UTC correction and the GPS signal.

16. The computer readable medium of claim 15 wherein the computer readable code for receiving a time zone reference signal at a telematics device comprises computer readable code for receiving a time zone reference signal on occurrence of an event selected from the group consisting of initial telematics device configuration, telematics device reconfiguration, a vehicle triggered event, and a system triggered event.

17. The computer readable medium of claim 15 wherein the time zone reference signal is a GPS signal and the computer readable code for determining a local Coordinated Universal Time (UTC) correction from the time zone reference signal comprises:
computer readable code for determining a vehicle location from the GPS signal;
computer readable code for determining a local time zone from the vehicle location; and
computer readable code for determining a local UTC correction for the local time zone.

18. The computer readable medium of claim 15 wherein the time zone reference signal is a Code Division Multiple Access (CDMA) signal including CDMA time and the computer readable code for determining a local Coordinated Universal Time (UTC) correction from the time zone reference signal comprises:
computer readable code for determining UTC time from the GPS signal; and
computer readable code for calculating a local UTC correction from the UTC time and the CDMA time.

19. The computer readable medium of claim 15 wherein the time zone reference signal is a Code Division Multiple Access (CDMA) signal including a CDMA local time correction and the computer readable code for determining a local Coordinated Universal Time (UTC) correction from the time zone reference signal comprises computer readable code for setting the UTC correction equal to the CDMA local time correction.

20. The computer readable medium of claim 15 further comprising computer readable code for scheduling mobile vehicle communication system activities based on the local time.
